(19) United States
(12) Patent Application Publication
(10) Pub. No.: US 2009/0204510 A1
(43) Pub. Date: Aug. 13, 2009

(54) SYSTEM AND METHOD FOR PAYING CHARGE OF INTERNET ITEM USING REQUEST OF GIFT IN MOBILE CONFIGURATION

(75) Inventor: Chang-Yeop Hwang, Seoul (KR)

Correspondence Address: EDWARDS ANGELL PALMER & DODGE LLP, P.O. BOX 55874, BOSTON, MA, 02205, US

(73) Assignee: MOBILIANS CO., LTD., Seoul (KR)

(21) Appl. No.: 12/281,965

(22) PCT Filed: Nov. 29, 2006
(86) PCT No.: PCT/KR2006/005092

§ 371 Date: Sep. 5, 2008

(30) Foreign Application Priority Data
Mar. 6, 2006 (KR) 10-2006-0021101

(51) Int. Cl. G06Q 30/00; G06Q 20/00; G06Q 10/00; H04W 4/00; G10L 15/26

(52) U.S. Cl. 705/27; 705/40; 705/26; 705/30; 705/34; 455/466; 704/235

(57) ABSTRACT

The present invention relates to wireless payment system and method in a mobile environment in which a sender makes a gift request for an internet item to a receiver using an MMS message and the sender is provided with the item according to payment of the receiver. The wireless payment system according to the present invention includes an item server for receiving a gift request MMS message for a specific item from a sender terminal, sending the gift request MMS message to a receiver terminal, receiving an approval result according to payment of the receiver, and if the approval result is success, providing the item to the sender; and a payment server for receiving connection of a payment request for gift purchase from the receiver terminal which received the MMS message, approving the payment request, and transmitting the approval result to the item server.

### TECHNICAL FIELD

The present invention relates to wireless payment system and wireless payment method in a mobile environment using a gift request for an internet item, and in particular to wireless payment system and method, in which when a member user transmits a gift request for an internet item to a non-member user, the non-member user who received the request makes wireless payment using a mobile terminal, and after payment is completed, the item is provided to an account of the member user who transmitted the request.

The internet item designated in the present invention is a concept covering avatars, game instruments (weapons), points, mileages, or cyber money (for example, “dotori”, i.e. a kind of electronic money, cyber cash, or cyber coin) that users purchase through cash payment, card payment or mobile payment in order to use a special service provided in a specific internet site.

### BACKGROUND ART

Conventionally, a user purchased a corresponding item directly by himself/herself to use a service provided in a specific internet site. Because the user used items through direct purchase, it resulted in limited occurrence of item purchase and contraction of service usage.

In order to solve the problems, an internet site allowed item transaction (exchange or assignment) between a user and another user so as to promote service usage of users, and introduced a gift service that if a member A pays for an internet item and selects a specific member B as a gift recipient, the paid internet item is presented to the member B as a gift.

The gift service diversifies transaction of internet items and promotes service usage to some extent, but it is applied only in the case that the users A and B are both members of the internet site. Thus, there is still a problem of limited service usage. That is, because item transaction is made through connection to an internet site between member users, in the case that a non-member user is to present an item to a member user, the non-member should apply for membership on the home page of the internet site and then use a gift service on the home page.

### DISCLOSURE OF INVENTION

Technical Problem

The present invention is designed to solve the problems of the prior art, and therefore it is an object of the present invention to provide a wireless payment system, in which when a sender writes a gift request MMS (Multimedia Messaging Service) message for an internet item and transmits it to a receiver on an internet site, if the receiver who received the MMS message pays for the internet item in a mobile environment, the purchased internet item is provided to the sender.

It is another object of the present invention to provide an MMS transmission service that a sender can select his/her character (i.e. avatar) on an internet site, and generate and edit a multimedia file containing a desired content.

Technical Solution

In order to achieve the above-mentioned objects, according to a wireless payment system in a mobile environment using a gift request for an internet item of the present invention, in the wireless payment system of an internet item using a gift request MMS that a sender transmits to a receiver, the wireless payment system includes an item server for receiving the gift request MMS message for a specific item from a sender terminal, sending it to a receiver terminal, receiving an approval result according to the receiver's payment for the item, and if the approval result is success, providing the item to the sender; and a payment server for receiving connection of a payment request for gift purchasing from the receiver terminal that has received the MMS message, approving the payment request, and transmitting the approval result to the item server, whereby if the receiver who is a member or non-member of the item server completes wireless payment using the MMS message, the item is provided to the sender who is a member.

According to the preferred embodiment of the present invention, the item server includes means for receiving the gift request from the sender terminal; means for providing the sender terminal with an MMS interface to generate the MMS message containing an internet item information including item name and price, a mobile phone number of the receiver terminal and a gift request message; means for transmitting the MMS message to a mobile server corresponding to the mobile phone number of the receiver so as to send the MMS message to the receiver terminal; and means for receiving an approval result of wireless payment of the receiver from the payment server, and if the approval result is success, providing the corresponding internet item to the sender.

Further, according to a wireless payment method in a mobile environment using a gift request for an internet item of the present invention, in the wireless payment method of an internet item using a gift request MMS that a sender transmits to a receiver, the wireless payment method includes the steps of: (S10) providing an internet item list at the request of a sender terminal made a member-connection to an item server and receiving a gift request for a specific item selected by a sender; (S20) providing the sender terminal with an MMS interface and generating an MMS message containing internet item information including item name and price, a mobile phone number of a receiver terminal and a gift request message; (S30) the item server sending the MMS message to the receiver terminal through a mobile server; (S40) the receiver terminal receiving payment selection from the receiver who checked the MMS message, and connecting to the payment server to transmit a payment request; (S50) the payment server receiving the payment request, performing payer verification and payment approval, and informing the item server and the receiver terminal of an approval result; and (S60) if the approval result is success, the item server providing a sender with the paid internet item, whereby if the receiver who is a member or non-member of the item server completes wireless payment using the MMS message, the item is provided to the sender who is a member.

### BRIEF DESCRIPTION OF THE DRAWINGS

Preferred embodiments of the present invention will be more fully described in the following detailed description, taken accompanying drawings. However, it should be understood that the description proposed herein is just a preferable example for the purpose of illustrations only, not intended to limit the scope of the invention. In the drawings:

FIG. 1 is a block diagram of a wireless payment system in accordance with an exemplary embodiment of the present invention.

FIG. 2 is a functional block diagram of an item server in accordance with an exemplary embodiment of the present invention.

FIG. 3 is an example view of an MMS message generated by the item server in accordance with an exemplary embodiment of the present invention.

FIG. 4 is a functional block diagram of a payment server in accordance with an exemplary embodiment of the present invention.

FIG. 5 is a whole flowchart of a wireless payment method in accordance with an exemplary embodiment of the present invention.

FIG. 6 is a detailed flowchart of an MMS message generating step in accordance with an exemplary embodiment of the present invention.

FIG. 7 is a detailed flowchart of an internet item payment processing step in accordance with an exemplary embodiment of the present invention.

### BEST MODE FOR CARRYING OUT THE INVENTION

Hereinafter, preferred embodiments of the present invention will be described in detail with reference to the accompanying drawings.

1. Configuration of System

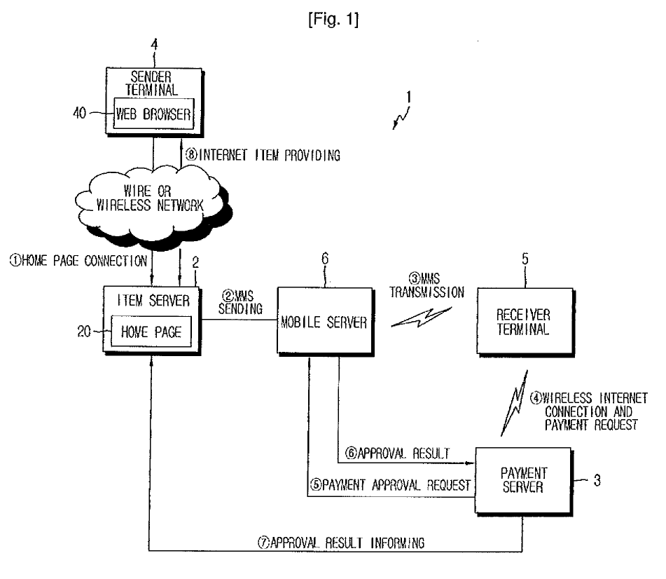

FIG. 1 is a block diagram of a wireless payment system 1 in accordance with an exemplary embodiment of the present invention.

The wireless payment system 1 according to an exemplary embodiment of the present invention includes an item server 2, a payment server 3, a sender terminal 4, a receiver terminal 5, and a mobile server 6.

The item server 2 has its home page 20, and is a contents provider (CP) server for providing contents such as game services or community services. Members of the home page 20 are provided with various contents services by purchasing, using and paying for internet items. The term, ‘item’ used in the present invention is a concept covering avatars, game instruments (weapons), points, mileages or cyber money (for example, “dotori”, i.e. a kind of electronic money, cyber cash or cyber coin). A sender who is a gift recipient, requests for an internet gift, designates a gift giver as a receiver, and writes and sends an MMS message.

Here, the item server 2 provides the sender terminal 4 with an MMS interface (for example, a web page input window) as an editing tool to support message writing of the sender, and the sender can select his/her avatar (character) or a specific avatar and edit his/her special message file through the MMS interface. For edition of the special message file, the sender is provided with a template file, and then the sender can edit a moving picture message in real time using the avatar. If the receiver receives the MMS message of the sender and successfully completed payment, the item server 2 is informed of an approval result from the payment server 3 and provides the paid item to the sender.

The payment server 3 is a server corresponding to a callback URL (Uniform Resource Locator) contained in the message received by the receiver. When the receiver requests payment, the receiver terminal 5 makes a wireless internet connection via the callback URL address to transmit a payment request for an item which the sender requests as a gift. The payment server 3 receives the payment request, performs payer verification, if a verification result is success, requests mobile payment to the mobile server 6, and receives an approval result. Here, the payer verification includes comparing a mobile phone number of the receiver contained in the MMS message with a mobile phone number of a payer (a receiver) who made a wireless internet connection. Therefore, on the assumption that the payer necessarily receives the MMS message from the sender, only in the case that the payer checks the message, makes a wireless internet connection through the same terminal, and pays for the item, the payer verification is determined to be success. When the payment server 3 receives the approval result as success from the mobile server 6, the payment server 3 informs the item server 2 that the payment-approved internet item gift will be provided to a member account of the sender.

The sender terminal 4 has a web browser 40 capable of connecting to an internet home page through a wire or wireless network, and includes a desktop computer, a notebook computer, a mobile phone or a PDA. The sender is provided with the MMS interface from the item server 2, writes a text message or a moving picture message, and makes a gift request for an internet item to the receiver.

The receiver terminal 5 has an MMS message receiving function and a wireless internet connection function, and includes a mobile phone or a PDA phone. The receiver checks the contents of the MMS message, reads the gift request of the sender, and selects acceptance or rejection of payment. If the receiver selects acceptance of payment, the receiver makes connection to the payment server 3 corresponding to the callback URL of the MMS message and transmits a payment request. The amount of the internet item to be paid is added to a communication charge of the receiver terminal and is charged on a designated date each month.

The mobile server 6 is a server of a communication provider for providing the receiver terminal 5 with a wireless communication service, and mediates MMS message transmission between the sender and the receiver. Also, the mobile server 6 receives a payment approval request of the receiver from the payment server 3, judges whether mobile phone rates of the receiver is overdue and whether to accept micro payment using a mobile phone, and charges the approved amount to be paid for the item together with communication rates of the receiver. By carrying out the present invention, the mobile communication provider can obtain a profit of an MMS transmission service from the sender and a profit of a payment approval service from the payment server 3.

1.1 Configuration of Item Server

FIG. 2 is a functional block diagram of the item server 2 in accordance with an exemplary embodiment of the present invention.

The item server 2 according to an exemplary embodiment of the present invention has functional components of the home page 20, including a gift request means 21, an MMS message generating means 22, an MMS message transmitting means 23 and an internet item providing means 24.

The gift request means 21 performs a function 212 for retrieving the item name and price from an item database (DB) 211 at the request of the sender, and generating and providing an internet item list. When the sender selects a specific item in the list and makes a gift request for the item, the gift request means 21 receives the request of the sender by its gift request receiving function 213.

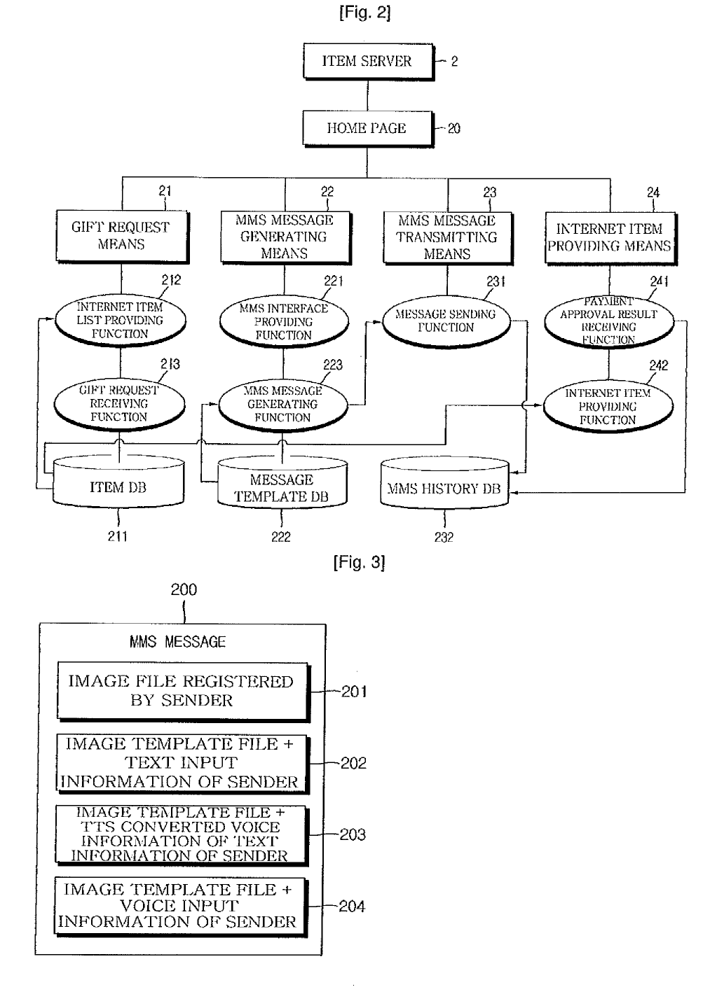

The MMS message generating means 22 performs a function 221 for providing the sender terminal 4 with the MMS interface according to the request. The sender can change selection of the internet item, input a phone number of the receiver terminal, and produce a file containing message contents. The avatar list and the template list retrieved from a message template DB 222 are provided to the sender terminal 4, and the sender selects a specific avatar and a specific template, and edits and produces an image file containing a gift request message using the MMS message generating function 223. Referring to FIG. 3, the MMS message 200 is any one selected from the group consisting of a moving picture image file 201 for gift requesting that the sender produces directly according to his/her selection, a text message 202 that the sender inputs into a message input window, a message 202 generated by combining the text information input by the sender with a specific template file selected by the sender from the image template list provided at the request of the sender, a message 203 generated by text-to-speech (TTS) converting the text information input by the sender into voice information and combining the voice information with the template file, and a message 204 generated by combining the template file with the voice information input by the sender. The image template file is formed in an animation format, and has such contents that the avatar selected by the sender makes a gift request to the receiver while playing a main character. And, the completed MMS message may be stored in an MMS history DB 232 for reuse according to selection of the sender.

The MMS message transmitting means 23 sends the MMS message to the receiver using a message sending function 231 when the sender selects sending, and stores the sent MMS message and a sending history in the MMS history DB 232 by selection of the sender.

The internet item providing means 24 is informed of the approval result from the payment server 3 by a payment approval result receiving function 241, and if the approval result is success, performs an internet item providing function 242, retrieves the payment-approved item from the item DB 211, and provides the item to the account of the sender.

1.2 Configuration of Payment Server

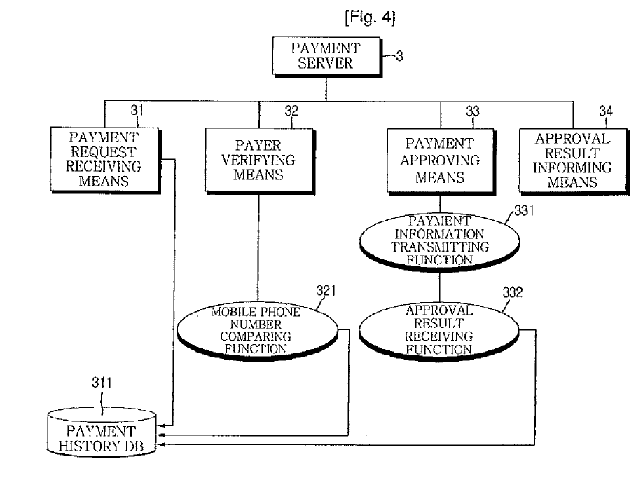

FIG. 4 is a functional block diagram of the payment server 3 in accordance with an exemplary embodiment of the present invention.

The payment server 3 according to an exemplary embodiment of the present invention includes a payment request receiving means 31, a payer verifying means 32, a payment approving means 33 and an approval result informing means 34.

The payment request receiving means 31 receives the wireless internet connection of the receiver terminal 5, and receives from the receiver terminal the payment request including a member ID of the sender of the item server, the amount to be paid for the item and the mobile phone number of the receiver contained in the MMS message, and the mobile phone number of the receiver terminal made a wireless internet connection for payment requesting. The payment request is stored in a payment history DB 311.

The member ID is used to make a request for providing an item of a payment-made purchase case to the ID of the sender. And, the mobile phone number of the receiver contained in the MMS message is used as a means for payer verification.

The payer verifying means 32 performs a mobile phone number comparing function 321 to compare the mobile phone number of the receiver contained in the received MMS message with the mobile phone number of the receiver terminal 5 made a wireless internet connection. This comparison accepts payer verification only in the case that the receiver who received the MMS message pays as a justifiable payer using the receiver terminal which received the message. A comparison result is stored in the payment history DB 311, and in the case that verification is failure, the approval result informing means 34 informs the receiver terminal 5 and the item server 2 of the approval result.

The payment approving means 33 performs a payment information transmitting function 331 in the case that the payer verification is success, to transmit a mobile phone number of the payer and the amount to be paid to the mobile server 6 and request payment approval, and performs an approval result receiving function 332 to receive the approval result of the request. The mobile server 6 retrieves whether a subscriber has subscribed a mobile communication service, credit state (whether mobile phone rates are paid), or acceptance or rejection of micro payment using a mobile phone, judges payment approval, and transmits the approval result to the payment server 3.

The approval result informing means 34 receives the approval result from the mobile server 6, and informs the item server 2 and the receiver terminal 5 of the approval result. If the item server 2 receives the approval result as success, the item server 2 provides the purchased internet item gift to the member account of the sender.

2. Configuration of Wireless Payment Method

A wireless payment method using a gift request for an internet item according to an exemplary embodiment of the present invention is embodied through construction of the above-mentioned wireless payment system 1.

The system 1 is configured such that the sender writes a gift request MMS message, transmits it to the receiver, and makes a gift request for a specific internet item sold in the item server 2. And, the system is configured such that the receiver makes a wireless internet connection to the payment server 3 using the receiver terminal 5 and completes payment, and then the item server 2 is informed of the payment approval result from the payment server 3 and provides the purchased internet item to the account of the sender.

2.1 Process for Transmitting Gift Request MMS Message

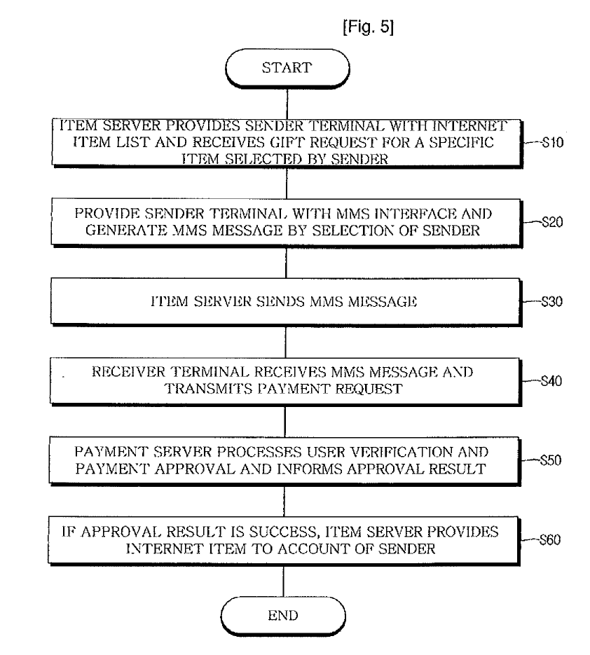

FIG. 5 is a whole flowchart of a wireless payment method in accordance with an exemplary embodiment of the present invention.

The sender drives the web browser 40 of the sender terminal 4, and makes a member-connection to the home page 20 of the item server 2 via a wire or wireless network. After member-connection, the sender requests for an internet item list to the item server 2, selects a specific item and transmits the MMS write request for a gift request (S10).

The item server 2 which received the request, provides the MMS interface (for example, a message input window) to the sender terminal 4, and generates the MMS message containing internet item information including the name and price of the item selected by the sender on the interface, the mobile phone number of the receiver terminal and a gift request message (S20).

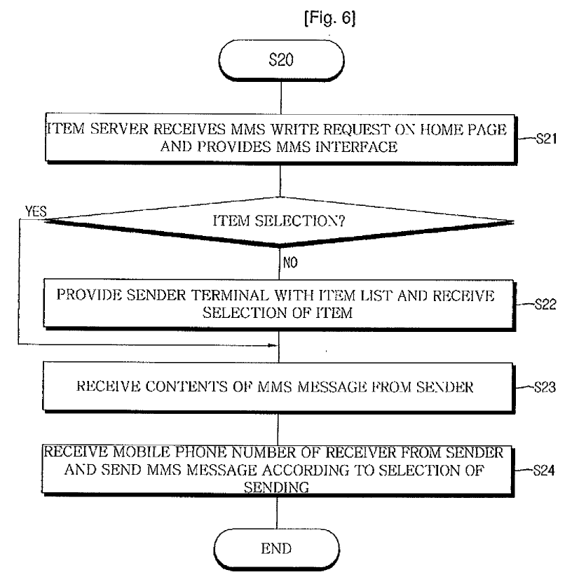

Specifically describing the step (S20) with reference to FIG. 6, the item server 2 receives the MMS write request from the sender terminal 4 and provides the MMS interface to the sender terminal 4 (S21). Here, in the case that the sender selects a specific internet item beforehand in the step (S10) and makes a gift request for the item, the internet item information is automatically indicated on the MMS interface. In the case that the sender makes a gift request without selecting an internet item beforehand, when the sender selects an internet item selection button located on the MMS interface, the item server 2 provides the sender with an item list so that the sender selects a specific item in the list (S22). When the internet item to be provided to the sender is selected, the item server 2 receives the contents of the message (S23).

In the step S23, the contents of the message is any one selected from the group consisting of a) an image file (for example, a moving picture file) for a gift request that the sender produced directly by himself/herself, b) a text message that the sender input in the message input window, c) a message generated by combining the text information input by the sender with a specific template file selected by the sender in an image template list provided to the sender at the request of the sender, d) a message generated by TTS converting the text information input by the sender into voice information and combining the voice information with the template file, and e) a message generated by combining the template file with the voice information input by the sender. The image template file is formed in an animation format, and has such contents that an avatar selected by the sender makes a gift request to the receiver while playing a main character. Preferably, the sender is provided with an avatar list and a template list from the item server 2, and selects a specific avatar and a specific template file, and edits and produces his/her special moving picture file.

When the MMS message is completely written, the sender inputs the mobile phone number of the receiver terminal 5 and the mobile communication provider, and selects a sending button (S24).

When the MMS message is completely sent through the above-mentioned step (S20), the item server 2 sends the MMS message to the receiver terminal 5 through the mobile server 6 corresponding to the mobile phone number of the receiver (S30).

2.2 Process for Processing Payment of Gift Request MMS Message

When the step S30 is completed, the receiver receives the MMS message through the receiver terminal 5, and checks the contents of a gift request message of the sender. When the receiver selects payment, the receiver makes a wireless internet connection to the payment server 3 using the callback URL contained in the MMS message and transmits a payment request for the internet item (S40).

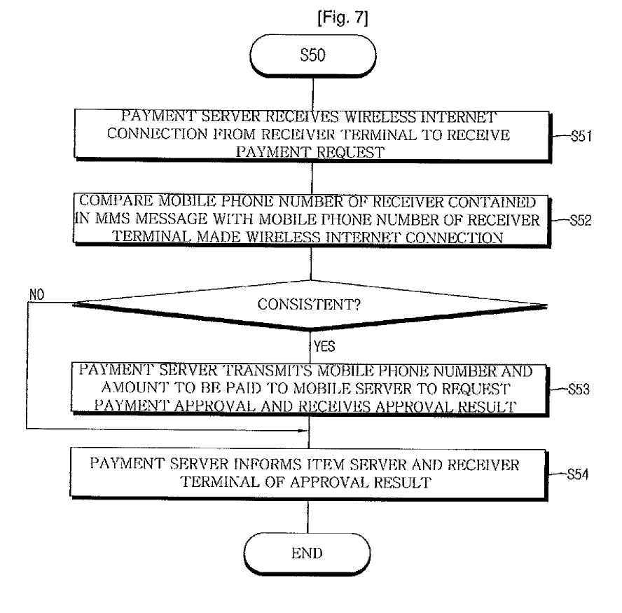

After the step S40 is performed, the payment server 3 receives the payment request, performs payer verification and payment approval, and informs the item server 2 and the receiver terminal 5 of the approval result (S50). Specifically describing the step (S50) with reference to FIG. 7, the payment server 3 receives wireless internet connection from the receiver terminal, and receives the payment request including a member ID of the sender of the item server 2, the amount to be paid for the internet item and the mobile phone number of the receiver contained in the MMS message, and the mobile phone number of the receiver terminal made a wireless internet connection for payment requesting (S51). Here, the member ID of the sender is a means for identifying who an internet item is to be presented to, and the mobile phone number of the receiver contained in the MMS message is a means for identifying whether a justifiable user makes a payment request by comparing with the mobile phone number of the payer (the receiver) who made a wireless internet connection.

The payment server 3 compares the mobile phone number of the receiver contained in the MMS message with the mobile phone number of the payer who made a wireless internet connection thereby to check if they are consistent with each other (S52). For example, according to a typical wireless payment method using a mobile phone on an internet webpage, when a user inputs his/her mobile phone number and makes a payment request, an approval number is transmitted to a mobile terminal corresponding to the mobile phone number of the user, and the user is required to input approval number into the webpage input window. This is to check if a true owner of the mobile phone pays in order to prevent fraudulent payment which may occur in the case that the third party inputs a mobile phone number of another person at his/her discretion. Therefore, the present invention compares the mobile phone number of the receiver contained in the MMS message with the mobile phone number of the receiver terminal 5 having made a wireless connection.

If the payer verification result is success through the above step S52, the payment server 2 transmits the mobile phone number and the amount to be paid for the item to the mobile server 6 to make a request for payment approval, and receives the approval result (S53). Here, the mobile server 6 determines payment approval according to whether a subscriber of the mobile phone number accepts micro payment and whether mobile phone rates are overdue, and transmits the approval result to the payment server 3. The payment server 3 informs the item server 2 and the receiver terminal 5 of the result when inconsistence occurs in the step (S52) or of the approval result (S54).

The step (S50) is performed so that the item server 2 is informed of the approval result (S60), and if the approval result is success, the item server 2 provides the paid internet item as a gift to the account of the member ID of the sender included in the approval result (S60).

The wireless payment system and wireless payment method using a gift request for an internet item in a mobile environment according to the present invention have been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### INDUSTRIAL APPLICABILITY

The wireless payment system and wireless payment method according to the present invention have an effect to provide a gift presenting service for an internet item that if the sender makes a gift request to the receiver using an MMS message and the receiver accepts the request through the MMS message, the sender is provided with the item paid by the receivers and uses the item.

Also, a member of an item selling internet site transmits a gift request to an opponent as a non-member through an MMS message and is presented with the item as a gift, and an MMS transmission fee of the sender and a wireless payment charge of the payer rendered in the process are the profit model of the gift presenting service.

1. A wireless payment system of an internet item using a gift request multimedia messaging service (MMS) transmitted from a sender to a receiver, the system comprising:
an item server for receiving a gift request MMS message for a specific item from a sender terminal, sending the gift request MMS message to a receiver terminal, receiving an approval result according to item payment of the receiver, and in the case that the approval result is success, providing the item to the sender; and
a payment server for receiving connection of a payment request for gift purchase from the receiver terminal that received the MMS message, approving the payment request, and transmitting the approval result to the item server, whereby, when the receiver who is a member or non-member of the item server completes wireless payment using the MMS message, the item is provided to the sender who is a member.

2. The system of claim 1, wherein the item server includes:
means for receiving the gift request from the sender terminal;
means for providing the sender terminal with an MMS interface to generate the MMS message containing internet item information including the name and price of the item, a mobile phone number of the receiver terminal and a gift request message;
means for transmitting the MMS message to a mobile server corresponding to a mobile phone number for sending the MMS message to the receiver terminal; and
means for receiving the approval result of wireless payment of the receiver from the payment server, and in the case that the approval result is success, providing a corresponding internet item to the sender.

3. The system of claim 1, wherein the item server includes:
an item database (DB) for storing information of the item including the name and price of the item selling to a user;
a message template DB for storing information of an avatar and an image template file selected by the sender on generating the MMS message; and
an MMS history DB for storing history information including the MMS message written by the sender, transmission state, and whether or not payment is completed.

4. The system of claim 1, wherein the item server includes:
function for receiving an image file from the sender terminal and attaching the image file to generate the MMS message;
function for providing an image template list to the sender terminal and combining a specific template file selected by the sender with a text information input by the sender to generate the MMS message;
function for text-to-speech (TTS) converting the text information input by the sender into voice information and combining the voice information with the template file selected by the sender in the image template list to generate the MMS message; and
function for combining the voice information input by the sender with the template file selected by the sender in the image template list to generate the MMS message.

5. The system of claim 1, wherein the payment server includes:
means for receiving the payment request from the receiver terminal, including a member ID of the sender of the item server, the amount to be paid for the item and the mobile phone number of the receiver contained in the MMS message, and the mobile phone number of the receiver terminal that made wireless internet connection for payment request;
means for comparing the mobile phone number of the receiver contained in the MMS message with a mobile phone number of a payer who made wireless internet connection to perform payer verification;
means for in the case that payer verification is success, transmitting the mobile phone number and the amount to be paid to the mobile server, requesting a payment approval and receiving a corresponding approval result; and means for receiving the approval result and informing the item server and the receiver terminal of the approval result.

6. The system of claim 1, wherein the payment server includes a payment history DB for storing payment request information received from the receiver terminal, the payer verification result by comparing with the mobile phone number of the receiver, and the payment approval result received from the mobile server.

7. The system of claim 1, further comprising:
the sender terminal connected to a home page of the item server through a wire or wireless network and provided with the MMS interface from the home page to write the MMS message and send the MMS message to the receiver;
the receiver terminal for, in case the receiver receives and checks the MMS message and selects payment, transmitting the payment request to the payment server through a wireless internet communication, the payment request including the member ID of the sender of the item server, the amount to be paid for the internet item and the mobile phone number of the receiver contained in the MMS message, the mobile phone number of the receiver terminal that made a wireless Internet connection for payment request;
the mobile server for transmitting the MMS message of the sender received from the item server to the receiver terminal, receiving the payment approval request including the mobile phone number of the receiver and the amount to be paid from the payment server, and responding to the payment approval result.

8. A wireless payment method of an internet item using a gift request MMS transmitted from a sender to a receiver, the method comprising the steps of:
(S10) providing an internet item list at the request of a sender terminal that made a member-connected to an item server, and receiving a gift request for a specific item selected by a sender;
(S20) providing an MMS interface to the sender terminal and generating an MMS message containing internet item information including item name and price, a mobile phone number of a receiver terminal, and a gift request message;
(S30) the item server sending the MMS message to the receiver terminal through a mobile server;
(S40) the receiver terminal receiving payment selection from a receiver who checked the MMS message, and being connected to the payment server to transmit a payment request;
(S50) the payment server receiving the payment request, performing payer verification and payment approval, and informing the item server and the receiver terminal of an approval result; and
(S60) in the case that the approval result is success, the item server providing a sender with the paid internet item, whereby, in the case that the receiver who is a member or non-member of the item server completes wireless payment using the MMS message, the item is provided to the sender who is a member.

9. The method of claim 8, wherein the step S20 includes the steps of:
(S21) the item server receiving a request for writing a gift request MMS message from the sender terminal through the home page of the item server and providing the MMS interface to the sender terminal;
(S22) receiving a request for item selection from the sender on the MMS interface, providing an item list and receiving selection of a specific item;
(S23) receiving the contents of the message on the MMS interface; and
(S24) receiving the mobile phone number of the receiver on the MMS interface, and sending the MMS message when a sending button is selected.

10. The method of claim 8, wherein the step S20 generates the MMS message having the contents including any one selected from the group consisting of:
a message generated with an image received from the sender terminal; a text message input by the sender;
a message generated by combining the text information input by the sender with a specific template file selected by the sender in an image template list provided to the sender terminal;
a message generated by TTS converting the text information input by the sender into voice information and combining the voice information with the template file; and
a message generated by combining the template file with voice information input by the sender.

11. The method of claim 10, wherein the step S20 generates the MMS message based on the template file using a specific avatar image selected by the sender in an avatar image list provided by the item server at the request of the sender.

12. The method of claim 8, wherein the step S50 includes the steps of:
(S51) the payment server receiving from the receiver terminal the payment request including a member ID of the sender, the amount to be paid for the item and the mobile phone number of the receiver contained in the MMS message, and the mobile phone number of the receiver terminal that made a wireless internet connection for payment request;
(S52) comparing the mobile phone number of the receiver contained in the MMS message with the mobile phone number of a payer who made a wireless internet connection to perform payer verification;
(S53) in the case that the payer verification is success, transmitting the mobile phone number and the amount to be paid to the mobile server, requesting a payment approval request, and receiving the corresponding approval result; and
(S54) informing the item server and the receiver terminal of the approval result.
